(19) United States
(12) Patent Application Publication
(10) Pub. No.: US 2016/0041490 A1
(43) Pub. Date: Feb. 11, 2016

(54) CHARGING MEMBER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: Noriko Suzumura, Mishima-shi (JP); Noriyuki Doi, Numazu-shi (JP); Masataka Kodama, Mishima-shi (JP); Hiroki Masu, Suntou-gun (JP)

(21) Appl. No.: 14/818,103

(22) Filed: Aug. 4, 2015

(30) Foreign Application Priority Data
Aug. 8, 2014 (JP) 2014-162928

(51) Int. Cl. B32B 9/04; G03G 15/02

(52) U.S. Cl. CPC G03G 15/0233

(57) ABSTRACT

A charging member includes a support and a surface layer. The surface layer contains a first compound and a second compound different from the first compound. The first compound is a polysiloxane having at least one unit selected from the group consisting of SiO_{4/2}(Q) unit, SiO_{3/2}(T) unit, and SiO_{2/2}(D) unit. The second compound is an acrylic polymer having a quaternary ammonium group and a group having an organosiloxane bond.

### BACKGROUND OF THE INVENTION

1. Field of the Invention

The present invention relates to a charging member, a process cartridge including the charging member, and an electrophotographic image forming apparatus (hereinafter referred to as an “electrophotographic apparatus”) including the charging member.

2. Description of the Related Art

In recent years, there has been a demand for electrophotographic image forming apparatuses having further improved endurance. To meet the demand, there is also a demand for charging members having stable chargeability for extended periods of time.

Degradation in chargeability of charging members is partly caused by adhesion of toner or a toner external additive to a charging member surface.

Japanese Patent Laid-Open No. 2007-004102 describes a charging member to which toner and toner external additives are less likely to adhere during repeated use over extended periods of time. The charging member includes a surface layer containing a polysiloxane having an alkyl fluoride group and an oxyalkylene group. Japanese Patent Laid-Open No. 2009-58635 describes a charging member containing a polysiloxane and a silicone oil in a surface layer. Toner and toner external additives are less likely to adhere to the charging member.

### SUMMARY OF THE INVENTION

In an electrophotographic process including the use of a negatively chargeable toner, part of the toner that is not transferred to a recording medium and remains on an electrophotographic photosensitive member (hereinafter also referred to as “untransferred toner”) includes weakly negatively charged toner or positively charged toner. Upon contact with a charging member, weakly negatively charged toner or positively charged toner is sometimes electrostatically attracted and adheres to the charging member surface.

According to the studies by the present inventors, it has been found that the charging members disclosed in Japanese Patent Laid-Open No. 2007-004102 and Japanese Patent Laid-Open No. 2009-58635 have some effects of preventing toner and toner external additives from adhering to the charging member surface. However, the present inventors have admitted that additional measures are needed to decrease the amount of toner electrostatically adhering to the charging member surface.

One aspect of the present invention is directed to providing a charging member that can suppress electrostatic adhesion of toner to the charging member surface and retain stable chargeability during long-term use. Another aspect of the present invention is directed to providing a process cartridge and an electrophotographic apparatus that can stably form high-quality electrophotographic images.

According to one aspect of the present invention, there is provided a charging member including a support and a surface layer, wherein the surface layer includes a first compound and a second compound different from the first compound, the first compound is a polysiloxane having at least one unit selected from the group consisting of SiO_{4/2}(Q) unit, SiO_{3/2}(T) unit, and SiO_{2/2}(D) unit, and the second compound is an acrylic polymer having a quaternary ammonium group and a group having an organosiloxane bond.

According to another aspect of the present invention, there is provided a process cartridge configured to integrally support an electrophotographic photosensitive member and a charging member, the charging member being configured to charge a surface of the electrophotographic photosensitive member, the process cartridge being attachable to and detachable from a main body of an electrophotographic apparatus, wherein the charging member is the aforementioned charging member.

According to still another aspect of the present invention, there is provided an electrophotographic apparatus that includes an electrophotographic photosensitive member and a charging member configured to charge a surface of the electrophotographic photosensitive member, wherein the charging member is the aforementioned charging member.

Further features of the present invention will become apparent from the following description of exemplary embodiments with reference to the attached drawings.

### BRIEF DESCRIPTION OF THE DRAWINGS

FIG. 1 is a cross-sectional view of a charging member according to an embodiment of the present invention.

FIG. 2 is a schematic view of a process cartridge and an image-forming apparatus according to an embodiment of the present invention.

FIG. 3 is a schematic view of an apparatus for measuring the charge polarity of a surface layer.

### DESCRIPTION OF THE EMBODIMENTS

The present inventors have found that a charging member containing a polysiloxane (a first compound) and an acrylic polymer having a quaternary ammonium group and a group having an organosiloxane bond (a second compound) different from the polysiloxane in a surface thereof has a particularly high chargeability to negatively charge toner. Thus, it was found that such a charging member can negatively charge weakly negatively charged untransferred toner or positively charged untransferred toner by triboelectric charging and thereby decrease the amount of untransferred toner adhering to the charging member.

Although the reason why a charging member according to an embodiment of the present invention has improved ability to negatively charge a toner is not clarified yet, it is considered that the Si—O bond of the polysiloxane generally has a high affinity for the group having the organosiloxane bond in the acrylic polymer. Thus, because of the interaction between the Si—O bond and the group having the organosiloxane bond, the quaternary ammonium group is selectively distributed to the surface of the charging member, thereby improving the negative chargeability of the charging member.

An embodiment of the present invention can provide a charging member that can suppress electrostatic adhesion of toner to the charging member surface and retain stable chargeability during long-term use. An embodiment of the present invention can also provide a process cartridge and an electrophotographic apparatus that can stably form high-quality electrophotographic images.

### Charging Member

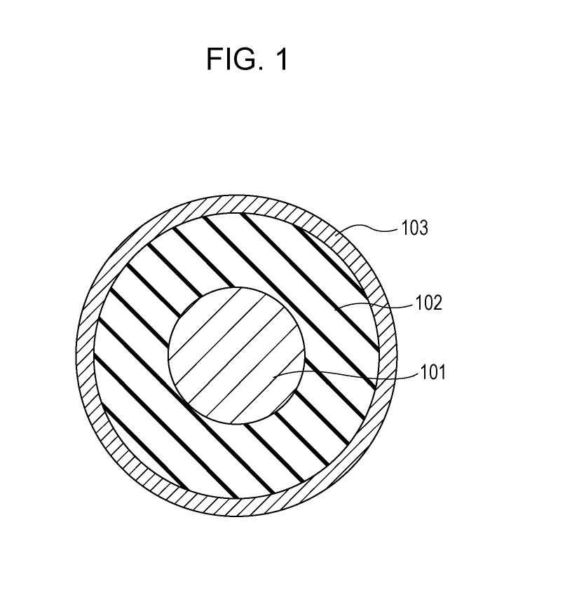

FIG. 1 is a cross-sectional view of a charging member according to an embodiment of the present invention. The charging member includes a support 101, a conductive elastic layer 102, and a surface layer 103.

### Support

The support 101 is electrically conductive. More specifically, the support 101 may be a metallic (alloy) support, for example, an iron, copper, stainless steel, aluminum, aluminum alloy, or nickel support.

### Conductive Elastic Layer

The conductive elastic layer 102 may be composed of one or two or more elastic members, such as rubber, for use in conductive elastic layers of known charging members. Examples of such rubber include, but are not limited to, urethane rubber, silicone rubber, butadiene rubber, isoprene rubber, chloroprene rubber, styrene-butadiene rubber, ethylene-propylene rubber, polynorbornene rubber, styrene-butadiene-styrene rubber, acrylonitrile rubber, epichlorohydrin rubber, and alkyl ether rubber.

The electrical resistance of the conductive elastic layer 102 can be adjusted with a conducting agent. Examples of the conducting agent include, but are not limited to, conductive carbon, such as ketjen black EC, acetylene black, carbon for rubber, oxidized carbon for color inks, and pyrolytic carbon. Graphite, such as natural graphite and synthetic graphite, may also be used.

The conductive elastic layer 102 may contain an inorganic filler and/or an organic filler and/or a crosslinking agent.

The conductive elastic layer 102 is formed on the support 101 by mixing the raw materials of conductive elastic members described above in a closed mixer and forming the mixture by a known method, such as extrusion, injection molding, or compression molding. The conductive elastic layer 102 is bonded to the support 101 with an adhesive agent, if necessary. The conductive elastic layer 102 on the support 101 is vulcanized, if necessary.

### Surface Layer

The surface layer 103 contains a first compound and a second compound different from the first compound. The first compound is a polysiloxane having at least one unit selected from the group consisting of SiO_{4/2}(Q) unit, SiO_{3/2}(T) unit, and SiO_{2/2}(D) unit. The second compound is an acrylic polymer having a quaternary ammonium group and a group having an organosiloxane bond.

### First Compound

The first compound is a polysiloxane having at least one unit selected from the group consisting of SiO_{4/2}(Q) unit, SiO_{3/2}(T) unit, and SiO_{2/2}(D) unit.

The polysiloxane can be produced by hydrolysis and condensation of a hydrolyzable silane compound. Examples of the hydrolyzable silane compound include, but are not limited to, tetraethoxysilane, tetramethoxysilane, tetra-n-propoxysilane, tetra-n-butoxysilane, methyltrimethoxysilane, methyltriethoxysilane, methyltripropoxysilane, ethyltrimethoxysilane, ethyltriethoxysilane, ethyltripropoxysilane, propyltrimethoxysilane, propyltriethoxysilane, propyltripropoxysilane, hexyltrimethoxysilane, hexyltriethoxysilane, hexyltripropoxysilane, decyltrimethoxysilane, decyltriethoxysilane, decyltripropoxysilane, phenyltrimethoxysilane, phenyltriethoxysilane, phenyltripropoxysilane, mercaptopropyltrimethoxysilane, vinyltrichlorosilane, vinyltriethoxysilane, dichlorosilane, and trichlorosilane. These hydrolyzable silane compounds may be used alone or in combination.

A polysiloxane having a constitutional unit represented by the following formula (4) can be produced by cleavage of an epoxy group in a hydrolyzed condensate of a hydrolyzable silane compound having the epoxy group.

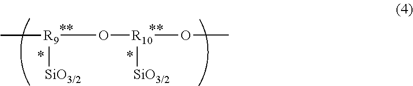

In the formula (4), R₉ and R₁₀ independently denote a structure represented by one of the following formulae (5) to (8):

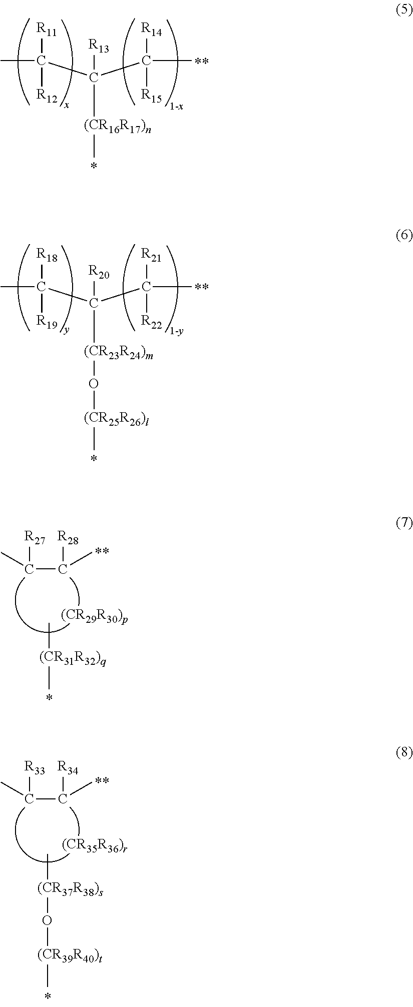

In the formulae (5) to (8), R₁₁ to R₁₅, R₁₈ to R₂₂, R₂₇, R₂₈, R₃₃, and R₃₄ independently denote a hydrogen atom, an alkyl group having 1 to 4 carbon atoms, a hydroxy group, a carboxy group, or an amino group, R₁₆, R₁₇, R₂₃ to R₂₆, R₃₁, R₃₂, and R₃₇ to R₄₀ independently denote a hydrogen atom or an alkyl group having 1 to 4 carbon atoms, R₂₉, R₃₀, R₃₅, and R₃₆ independently denote a hydrogen atom, an alkoxy group having 1 to 4 carbon atoms, or an alkyl group having 1 to 4 carbon atoms, n, m, l, q, s, and t are independently an integer of 1 or more and 8 or less, p and r are independently an integer of 4 or more and 12 or less, and x and y are independently 0 or 1. The symbol “*” represents a binding site with a silicon atom in the formula (4). The symbol “**” represents a binding site with an oxygen atom disposed on the right of R₉ in the formula (4) in the case that R₉ in the formula (4) denotes a structure having one of the formulae (5) to (8) and represents a binding site with an oxygen atom disposed on the right of R₁₀ in the formula (4) in the case that R₁₀ in the formula (4) denotes a structure having one of the formulae (5) to (8).

More specifically, in the formula (4), R₉ and R₁₀ can independently denote a structure represented by one of the following formulae (10) to (13).

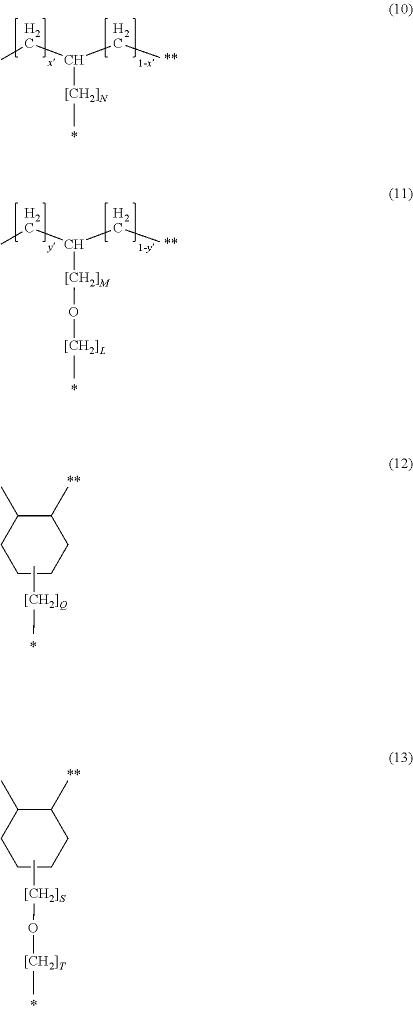

In the formulae (10) to (13), N, M, L, Q, S, and T are independently an integer of 1 or more and 8 or less, and x′ and y′ are independently 0 or 1. The symbols “*” and “**” are the same as in the formulae (5) to (8).

Specific examples of the hydrolyzable silane compound having an epoxy group include, but are not limited to, 4-(1,2-epoxybutyl)trimethoxysilane, 4-(1,2-epoxybutyl)triethoxysilane, 5,6-epoxyhexyltrimethoxysilane, 5,6-epoxyhexyltriethoxysilane, 8-oxiran-2-yloctyltrimethoxysilane, 8-oxiran-2-yloctyltriethoxysilane, glycidoxypropyltrimethoxysilane, glycidoxypropyltriethoxysilane, 2-(3,4-epoxycyclohexyl)ethyltrimethoxysilane, 2-(3,4-epoxycyclohexyl)ethyltriethoxysilane, 3-(3,4-epoxycyclohexyl)methyloxypropyltrimethoxysilane, and (3-(3,4-epoxycyclohexyl)methyloxypropyltriethoxysilane. These hydrolyzable silane compounds having an epoxy group may be used alone or in combination.

The polysiloxane produced by hydrolysis and condensation of a hydrolyzable silane compound has at least one of the SiO_{4/2}(Q) unit and the SiO_{3/2}(T) unit.

The polysiloxane may be a modified silicone oil. The modified silicone oil is a polysiloxane having the SiO_{2/2}(D) unit.

The modified silicone oil is a polysiloxane having an organic group, such as an alkoxy group having 1 to 3 carbon atoms, an amino group, an epoxy group, and/or a carboxy group, on a side chain and/or at an end thereof.

Among these, the modified silicone oil may be an alkoxy modified silicone oil having an alkoxy group as an organic group. The alkoxy modified silicone oil, together with the hydrolyzable silane compound, can be subjected to hydrolysis and condensation. Thus, the surface layer 103 can have good film-forming properties. The polysiloxane produced in this manner has at least the SiO_{3/2}(T) unit as well as the SiO_{2/2}(D) unit.

The organic group of the organosiloxane skeleton of the modified silicone oil may be, but is not limited to, an alkyl group having 1 to 3 carbon atoms and/or a phenyl group. The organosiloxane skeleton of the modified silicone oil can have a dimethylorganosiloxane skeleton in terms of productivity.

More specifically, the modified silicone may be an alkoxy modified polydimethylsilicone (trade name: FZ-3527, manufactured by Dow Corning Toray Co., Ltd.).

The polysiloxane may be a ladder silicone or a ladder-silicone-modified acrylic polymer. The ladder silicone and ladder-silicone-modified acrylic polymer are polysiloxanes having at least the SiO_{3/2}(T) unit.

The ladder silicone is a polysiloxane having a ladder organopolysiloxane structure. More specifically, the ladder silicone is a polysiloxane having a constitutional unit represented by the following formula (101).

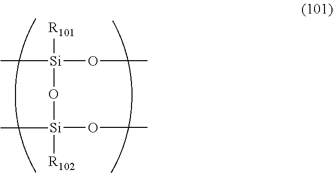

In the formula (101), R101 and R102 independently denote an alkyl group having 1 to 3 carbon atoms or a substituted or unsubstituted phenyl group.

The ladder-silicone-modified acrylic polymer is an acrylic polymer having the ladder organopolysiloxane structure. More specifically, the ladder-silicone-modified acrylic polymer is an acrylic polymer having a constitutional unit represented by the following formula (102).

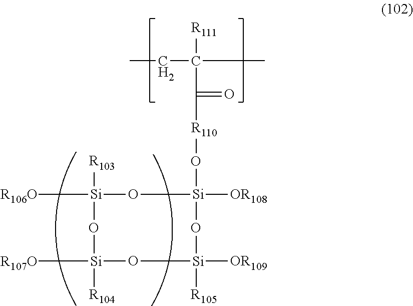

In the formula (102), R103 to R105 independently denote an alkyl group having 1 to 3 carbon atoms or a substituted or unsubstituted phenyl group, R106 to R109 independently denote a hydrogen atom, an alkyl group having 1 to 3 carbon atoms, or a trialkylsilyl group having 1 to 3 carbon atoms, R110 denotes an alkylene group having 1 to 6 carbon atoms, and R111 denotes a hydrogen atom or an alkyl group having 1 to 3 carbon atoms. R106 to R109 are independently preferably a trimethylsilyl group, and R111 is preferably a hydrogen atom.

The acrylic skeleton of the ladder-silicone-modified acrylic polymer can have a constitutional unit represented by the following formula (103).

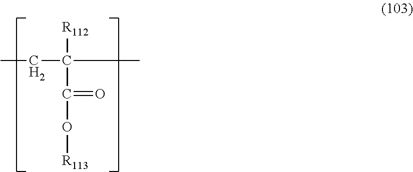

In the formula (103), R112 denotes an alkyl group having 1 to 3 carbon atoms, and R113 denotes a hydrogen atom, an alkyl group having 1 to 10 carbon atoms, or an alkoxy group having 1 to 10 carbon atoms. R112 is preferably a methyl group.

More specifically, the ladder-silicone-modified acrylic polymer may be a ladder-silicone-modified acrylic polymer SQ100 or SQ200 (trade name, manufactured by Tokushiki Co., Ltd.).

The surface layer 103 can be composed of the ladder silicone and/or the ladder-silicone-modified acrylic polymer alone or in combination. The surface layer 103 can be formed by hydrolysis and condensation of the ladder silicone and/or the ladder-silicone-modified acrylic polymer together with the hydrolyzable silane compound.

The surface layer 103 may further have a constitutional unit represented by the following formula (9).

TiO_{4/2} (9)

When the polysiloxane has the constitutional unit represented by the formula (9), the surface layer 103 has improved film strength, and the charging member is more resistant to external frictional forces from another member (for example, an electrophotographic photosensitive member).

The surface layer having the constitutional unit represented by the formula (9) can be formed by hydrolysis and condensation of the hydrolyzable silane compound together with a hydrolyzable titanium compound. Examples of the hydrolyzable titanium compound include, but are not limited to, titanium methoxide, titanium ethoxide, titanium n-propoxide, titanium i-propoxide, titanium n-butoxide, titanium t-butoxide, titanium i-butoxide, titanium nonyloxide, titanium 2-ethylhexoxide, and titanium methoxypropoxide.

### Second Compound

The second compound is an acrylic polymer having a quaternary ammonium group and a group having an organosiloxane bond.

The quaternary ammonium group can have a structure represented by the following formula (1).

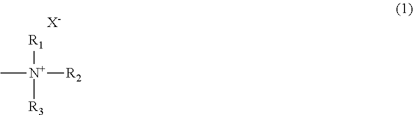

In the formula (1), R₁ to R₃ independently denote a hydrogen atom, an alkyl group having 1 to 10 carbon atoms, a phenyl group, an alkoxy group having 1 to 10 carbon atoms, or a phenoxy group, and X⁻ denotes an anion.

The group having an organosiloxane bond can have a structure represented by the following formula (2).

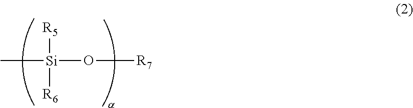

In the formula (2), R₅ and R₆ independently denote a hydrogen atom or an alkyl group having 1 to 3 carbon atoms, R₇ denotes a hydrogen atom, an alkyl group having 1 to 6 carbon atoms, or a group represented by the following formula (3). In the formula (2), α is an integer of 1 or more, preferably 1 or more and 200 or less.

—Si(CH₃)₃ (3)

The acrylic polymer having the quaternary ammonium group functions to negatively charge untransferred toner. Because the quaternary ammonium group is in the acrylic polymer skeleton, the electrically conductive component does not bleed, and the charging member can maintain a stable ability to charge a toner negatively for extended periods of time. In contrast, when the quaternary ammonium salt is mixed with the acrylic polymer, the quaternary ammonium salt may bleed from the surface layer during use of the charging member.

Furthermore, the acrylic polymer having the group having an organosiloxane bond is compatible with the polysiloxane. Thus, because of the interaction between the polysiloxane and the group having the organosiloxane bond, the quaternary ammonium group is selectively distributed to the surface of the charging member.

The quaternary ammonium group and the group having an organosiloxane bond can be a side chain of the acrylic polymer.

X⁻ of the quaternary ammonium group is an anion of, for example, halogen, an inorganic salt, such as hydrochloric acid, hydrobromic acid, sulfuric acid, phosphoric acid, or nitric acid, or an organic acid, such as carboxylic acid or organic sulfonic acid. More specifically, X⁻ may be Br⁻, Cl⁻, HSO₄⁻, H₂PO₄⁻, NO₃⁻, a methylsulfonate ion, or a p-toluenesulfonate ion. X⁻ is preferably a methylsulfonate ion or a p-toluenesulfonate ion in terms of triboelectric chargeability.

The acrylic polymer can be synthesized by polymerization of a polymerizable acrylic compound, which is a raw material of the acrylic polymer. The acrylic polymer can be synthesized by polymerization of acrylic monomers represented by the following formulae (14) and (15). If necessary, the acrylic monomers represented by the following formulae (14) and (15) can be copolymerized with an acrylic monomer represented by the following formula (16). Each of the acrylic monomers represented by the formulae (14) to (16) may be multiple types of acrylic monomers.

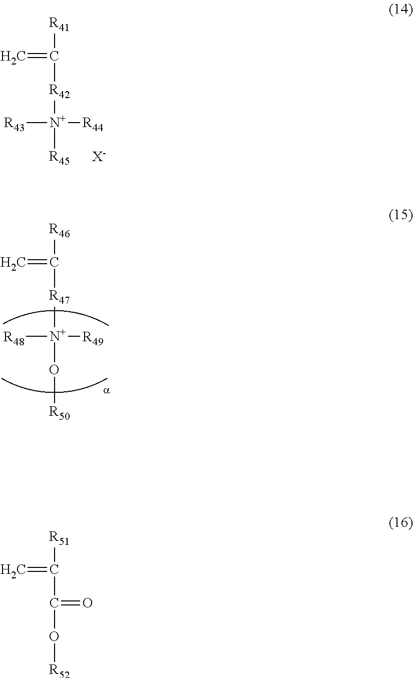

In the formula (14) to (16), R₄₁, R₄₆, and R₅₁ independently denote a hydrogen atom or an alkyl group having 1 to 3 carbon atoms. In the formula (14), R₄₃ to R₄₅ independently denote a hydrogen atom, an alkyl group having 1 to 10 carbon atoms, a phenyl group, an alkoxy group having 1 to 10 carbon atoms, or a phenoxy group, R₄₂ denotes a divalent group having a structure represented by —COO—, and X⁻ denotes the anion described above. In the formula (15), R₄₈ and R₄₉ independently denote a hydrogen atom or an alkyl group having 1 to 3 carbon atoms, R₅₀ denotes a hydrogen atom, an alkyl group having 1 to 6 carbon atoms, or a group represented by the formula (3), R₄₇ denotes a divalent group having a structure represented by —COO— or —O—, and α is as described above. In the formula (16), R₅₂ denotes an alkyl group having 1 to 18 carbon atoms.

The acrylic polymer synthesized in this manner includes a constitutional unit represented by the following formulae (17) to (19).

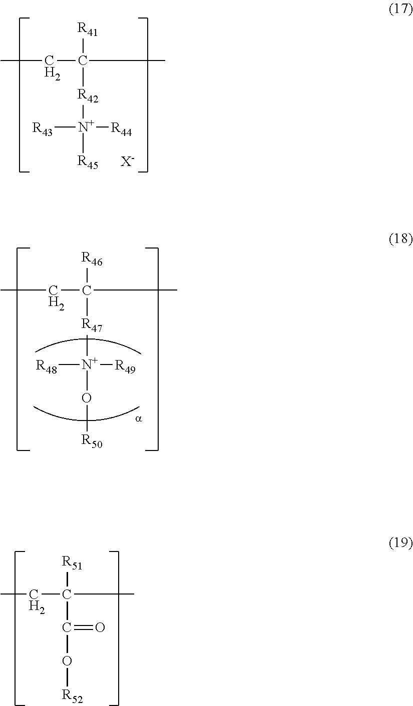

In the formula (17) to (19), R₄₁, R₄₆, and R₅₁ independently denote a hydrogen atom or an alkyl group having 1 to 3 carbon atoms. In the formula (17), R₄₃ to R₄₅ independently denote a hydrogen atom, an alkyl group having 1 to 10 carbon atoms, a phenyl group, an alkoxy group having 1 to 10 carbon atoms, or a phenoxy group, R₄₂ denotes a divalent group having a structure represented by —COO—, and X⁻ denotes the anion described above. In the formula (18), R₄₈ and R₄₉ independently denote a hydrogen atom or an alkyl group having 1 to 3 carbon atoms, R₅₀ denotes a hydrogen atom, an alkyl group having 1 to 6 carbon atoms, or a group represented by the formula (3), R₄₇ denotes a divalent group having a structure represented by —COO— or —O—, and α is as described above. In the formula (19), R₅₂ denotes an alkyl group having 1 to 18 carbon atoms.

The acrylic polymer can be produced by a known polymerization method, such as bulk polymerization, suspension polymerization, or emulsion polymerization. Reactions can be easily controlled by solution polymerization. Solvents for use in solution polymerization may be any solvents that can homogeneously dissolve acrylic polymers, and can include lower alcohols, such as methanol, ethanol, n-butanol, and isopropanol. Lower alcohols can decrease the viscosity of coating solution and facilitate the film formation of applied resin layers. Lower alcohols may be used in combination with another solvent, if necessary. The amount of solvent to be used in solution polymerization is preferably 25 parts or more and 400 parts or less by mass per 100 parts by mass of the monomer components in order to control the viscosity within an appropriate range. The monomer mixture can be polymerized in the presence of a polymerization initiator in an inert gas atmosphere at a temperature of 50° C. or more and 100° C. or less.

Examples of the polymerization initiator include, but are not limited to, t-butylperoxy-2-ethylhexanoate, t-butyl peroxypivalate, t-butyl peroxylaurate, benzoyl peroxide, lauroyl peroxide, octanoyl peroxide, di-t-butyl peroxide, t-butylcumyl peroxide, dicumyl peroxide, 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), and dimethyl 2,2′-azobis(2-methylpropionate). These polymerization initiators may be used alone or in combination.

Although the polymerization initiator is generally added to the monomer solution before polymerization, part of the polymerization initiator may be added to the monomer solution during polymerization in order to decrease the amount of unreacted monomers. The polymerization may be promoted by ultraviolet and/or electron beam radiation. These methods may be used in combination. The amount of polymerization initiator to be used is 0.05 parts or more and 30 parts or less by mass, particularly 0.1 parts or more and 15 parts or less by mass, per 100 parts by mass of the monomer components. The amount of polymerization initiator in this range results in a decreased amount of residual monomers, and the molecular weight of the acrylic polymer can be easily controlled.

The monomer (14) may be produced by quaternizing a monomer represented by the following formula (20) with a quaternizing agent.

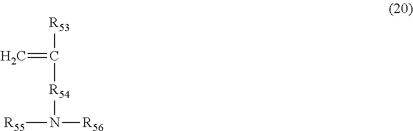

In the formula (20), R₅₃ denotes a hydrogen atom or an alkyl group having 1 to 3 carbon atoms, and R₅₄ denotes a divalent group having a structure represented by —COO—.

Specific examples of the quaternizing agent include, but are not limited to, butyl bromide, 2-ethylhexyl bromide, octyl bromide, lauryl bromide, stearyl bromide, butyl chloride, 2-ethylhexyl chloride, octyl chloride, and lauryl chloride. The amount of quaternizing agent to be used is preferably 0.8 mol or more and 1.0 mol or less per mole of the monomer (18). Monomers can be quaternized by heating the monomers together with a quaternizing agent to a temperature of 60° C. or more and 90° C. or less in a solvent.

After copolymerization of the monomers (15), (16), and (20), the copolymer can be quaternized with a quaternizing agent to produce an acrylic copolymer having a desired quaternary ammonium group. Alternatively, for example, the monomer (20) is quaternized with an alkyl halide, such as methyl chloride, and is copolymerized with the monomers (15) and (16). The resulting acrylic copolymer having a quaternary ammonium group may be subjected to counterion exchange by treatment with an acid, such as p-toluenesulfonic acid or hydroxynaphthalene sulfonic acid, thereby producing an acrylic copolymer having a quaternary ammonium group having an intended anionic species.

The ratios of the constitutional units of the acrylic polymer are as follows: a/(a+b+c) is preferably 0.3 or more and 0.8 or less, b/(a+b+c) is preferably 0.2 or more and 0.7 or less, and c/(a+b+c) is preferably 0.0 or more and 0.5 or less, wherein a [mol] denotes the number of moles of the constitutional unit represented by the formula (17), b [mol] denotes the number of moles of the constitutional unit represented by the formula (18), and c [mol] denotes the number of moles of other constitutional units (including the constitutional unit represented by the formula (19)) in acrylic polymerization. When a/(a+b+c) is 0.3 or more, and b/(a+b+c) is 0.2 or more and 0.7 or less, the constitutional unit represented by the formula (17) is more likely to be distributed to the surface of the charging member and this results in improved chargeability of the charging member to charge toner.

The acrylic polymer preferably has a weight-average molecular weight of 5,000 or more and 100,000 or less. The weight-average molecular weight is determined by the method described in the exemplary embodiments.

The acrylic polymer may be a commercial product, such as “1SX-1055S” (trade name) manufactured by Taisei Fine Chemical Co., Ltd.

### Method for Forming Surface Layer

The surface layer 103 can be formed in the following reaction process.
(I-1) A step of hydrolysis and condensation of a hydrolyzable silane compound in the presence of water and an alcohol to produce a condensate.
(I-2) A step of mixing the condensate of the step (I-1) with an acrylic polymer.
(I-3) A step of adjusting the solid content of the liquid mixture of the step (I-2), if necessary, to produce a coating solution for forming the surface layer.
(I-4) A step of applying the coating solution for forming the surface layer of the step (I-3) to the conductive elastic layer 102 on the support 101 and drying the coating solution to form a coating film for the surface layer.
(I-5) A step of curing the coating film by heating and/or active energy radiation, if necessary.

When a polysiloxane other than polysiloxanes produced from hydrolyzable silane compounds, more specifically, a modified silicone oil, ladder silicone, or ladder-silicone-modified acrylic polymer is used, the step (I-1) can be omitted, and the polysiloxane can be used instead of the condensate in the step (I-2) to form the surface layer 103. In the step (I-1), a hydrolyzable silane compound and/or a hydrolyzable titanium compound may be mixed with the polysiloxane, and the mixture may be subjected to hydrolysis and condensation in the presence of water and an alcohol.

### Step (I-1)

A hydrolyzable silane compound is subjected to hydrolysis and condensation in the presence of water and an alcohol. When the surface layer 103 includes the constitutional unit represented by the formula (9), the hydrolyzable silane compound is used in combination with a hydrolyzable titanium compound.

The ratio of the amount of the water to the total amount of the hydrolyzable silane compound and the hydrolyzable titanium compound (hereinafter collectively referred to as a “hydrolyzable compound”) is preferably 0.3 or more and 6.0 or less (mole ratio). When the mole ratio of water to the hydrolyzable compound is 0.3 or more, this results in an efficient hydrolysis reaction and condensation reaction and decreased amounts of unreacted monomers in the condensate. When the mole ratio of water to the hydrolyzable compound is 0.6 or less, the condensation reaction is prevented from proceeding rapidly, and the reaction solution has reduced cloudiness and precipitation.

The alcohol can be a primary alcohol, a secondary alcohol, a tertiary alcohol, a mixture of a primary alcohol and a secondary alcohol, or a mixture of a primary alcohol and a tertiary alcohol, in terms of compatibility. In particular, use of ethanol, a mixture of methanol and 2-butanol, or a mixture of ethanol and 2-butanol can improve the coatability of the coating solution. The amount of alcohol is preferably 10 to 1000 parts by mass per 100 parts by mass of the hydrolyzable compound. The amount of alcohol affects the hydrolysis and condensation reaction rate of the hydrolyzable silane compound and is therefore appropriately controlled.

The hydrolysis and condensation reaction may be performed at normal temperature and may be performed at high temperatures, if necessary.

### Step (I-2)

The condensate produced in the step (I-1) is mixed with the acrylic polymer.

The amount of acrylic polymer is preferably 1 part or more and 80 parts or less by mass per 100 parts by mass of the condensate. When the amount of acrylic polymer is 1 part or more by mass, the charging member has high chargeability to negatively charge toner. When the amount of acrylic polymer is 80 parts or less by mass, the constitutional unit represented by the formula (17) is more likely to be distributed to the surface of the charging member.

When the surface layer 103 is formed from a hydrolyzable silane compound having an epoxy group, a cationic polymerization initiator that is a photopolymerization initiator can be added in this step to improve cross-linking efficiency. The cationic polymerization initiator can be a Lewis acid onium salt. The epoxy group has high reactivity to a Lewis acid onium salt activated by active energy radiation.

Examples of other cationic polymerization initiators include, but are not limited to, borates, compounds having an imide structure, compounds having a triazine structure, azo compounds, and peroxides. Among various cationic polymerization initiators, aromatic sulfonium salts and aromatic iodonium salts have high sensitivity, stability, and reactivity. More specifically, the cationic polymerization initiator can be “SP-150” (trade name, manufactured by Adeka Corporation) or “Irgacure 250” (trade name, BASF Japan Ltd.).

The amount of cationic polymerization initiator preferably ranges from 0.001 to 0.050 mol per epoxy equivalent.

### Step (I-3)

The solid content of the liquid mixture of the step (I-2) is adjusted, if necessary, to produce a coating solution for forming the surface layer.

The solid content of the coating solution for forming the surface layer is preferably 0.05% or more and 10.0% or less by mass in order to improve the coatability of the coating solution and prevent nonuniform coating.

The solid content can be adjusted with an alcohol, such as ethanol or 2-butanol, an ester, such as ethyl acetate, a ketone, such as methyl ethyl ketone, or a mixture thereof. A coating film having less coating nonuniformity can be formed in an appropriate drying time by using these solvents.

### Step (I-4)

The coating solution for forming the surface layer of the step (I-3) is applied to the conductive elastic layer 102 on the support 101 and is dried to form a coating film for the surface layer 103. The coating solution can be applied by coating with a roll coater, by dip coating, or by ring coating.

### Step (I-5)

In the multilayer body on which the coating film for the surface layer 103 is formed in the step (I-4), the coating film is cured by heating and/or active energy radiation, if necessary.

In order to cure the coating film, the condensate or polysiloxane can be cured by heating and/or ultraviolet radiation. The surface layer 103 thus formed has high endurance.

The method for curing the coating film can depend on the types of condensate and polysiloxane. For example, a polysiloxane containing a thermosetting acrylic can be cured by heating.

In particular, when the condensate is produced from a hydrolyzable silane compound having an epoxy group in the step (I-1), the condensate is polymerized by cleavage of the epoxy group. Thus, the coating film can be exposed to active energy radiation. Active energy radiation promotes the polymerization of the condensate and cures the coating film, thereby improving the endurance of the surface layer 103.

The surface layer 103 can be cured by heating at 160° C. or less. Heating at a temperature of 160° C. or less can prevent hardening of the conductive elastic layer 102.

When the surface layer 103 is cured by active energy radiation, ultraviolet radiation can be used. Ultraviolet radiation rarely generates extra heat while the surface layer 103 is cured. Unlike heat curing, curing by ultraviolet radiation rarely causes phase separation during evaporation of the solvent and can form uniform films. The charging member thus produced can evenly supply consistent potential to the electrophotographic photosensitive member.

High-pressure mercury lamps, metal halide lamps, low-pressure mercury lamps, and excimer UV lamps can be used for ultraviolet radiation. In particular, ultraviolet light sources for emitting light mainly having an ultraviolet wavelength of 150 nm or more and 480 nm or less may be used. The integral ultraviolet light quantity can depend on the type and amount of raw materials of the surface layer 103 and on the thickness of the surface layer 103, and can be determined so as to sufficiently cure the coating film. The integral ultraviolet light quantity is defined by the following formula (21).

Integral ultraviolet light quantity [mJ/cm²]=Ultraviolet radiation intensity [mW/cm²]×Radiation time [s] (21)

The integral ultraviolet light quantity can be adjusted by the radiation time, the lamp output, and/or the distance between the lamp and the irradiated body. The integral light quantity may be increased or decreased during the radiation time.

When the ultraviolet light source is a low-pressure mercury lamp, the integral ultraviolet light quantity can be measured with an accumulated UV meter UIT-150-A or UVD-S254 manufactured by Ushio Inc. When the ultraviolet light source is an excimer UV lamp, the integral ultraviolet light quantity can be measured with an accumulated UV meter UIT-150-A or VUV-S172 manufactured by Ushio Inc.

In all of the exemplary embodiments described below, ultraviolet radiation was performed to improve the lubricity of the conductive elastic layer 102.

### Electrophotographic Apparatus and Process Cartridge

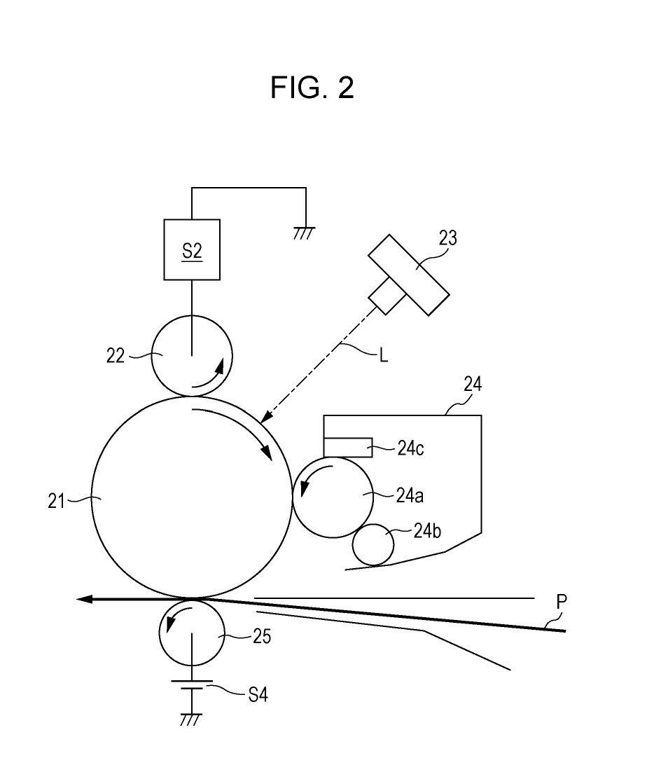

FIG. 2 is a schematic view of an electrophotographic apparatus equipped with a process cartridge having a charging member according to an embodiment of the present invention.

An electrophotographic photosensitive member 21 is a rotating-drum image-bearing member and rotates clockwise in the direction of the arrow at a predetermined circumferential velocity (process speed).

A charging roller 22 is brought into contact with the electrophotographic photosensitive member 21 by predetermined pressing force and rotates in the forward direction with respect to the rotation of the electrophotographic photosensitive member 21. A charging bias supply S2 applies a predetermined direct-current voltage (−1050 V in the exemplary embodiments) to the charging roller 22. Thus, the surface of the electrophotographic photosensitive member 21 is evenly charged to a predetermined polar potential (a dark potential of −500 V in the exemplary embodiments).

An exposure device 23 performs image exposure to the charged surface of the electrophotographic photosensitive member 21 on the basis of the intended image information. This selectively decreases (attenuates) the potential of the exposed bright portion on the charged surface of the electrophotographic photosensitive member 21 (a bright potential of −150 V in the exemplary embodiments), thereby forming an electrostatic latent image on the electrophotographic photosensitive member 21. The exposure device 23 may be a known device, for example, a laser beam scanner.

A developing device 24 includes a toner carrier 24a, a stirring member 24b, and a toner regulating member 24c. The toner carrier 24a is disposed in an opening portion of a developer container for storing toner and conveys the toner. The stirring member 24b stirs the stored toner. The toner regulating member 24c regulates the loading of the toner (the thickness of the toner layer) on the toner carrier 24a. The developing device 24 selectively deposits toner charged with the same polarity as the electrophotographic photosensitive member 21 (negatively charged toner) on the exposed bright portion of the electrostatic latent image formed on the surface of the electrophotographic photosensitive member 21, thereby visualizing the electrostatic latent image as a toner image (the developing bias was −400 V in the exemplary embodiments). The developing device 24 can be a known device. The developing method may be any known method; for example, a jumping developing method, a contact developing method, or a magnetic brush method. In particular, in the case of image-forming apparatuses for outputting color images, the contact developing method can reduce scattering of toner.

A transfer roller 25 may be a known roller. For example, the transfer roller 25 may be formed by covering the metallic conductive support 101 with an elastomeric resin layer having moderate resistance. The transfer roller 25 is brought into contact with the electrophotographic photosensitive member 21 by predetermined pressing force and rotates at substantially the same circumferential velocity as the electrophotographic photosensitive member 21 in the forward direction with respect to the rotation of the electrophotographic photosensitive member 21. A transfer bias supply S4 applies a transfer voltage to the transfer roller 25 with polarity opposite to that of toner. A recording medium P is fed from a sheet feeding mechanism (not shown) to the contact portion between the electrophotographic photosensitive member 21 and the transfer roller 25 at a predetermined timing. The transfer roller 25 to which the transfer voltage is applied charges the back surface of the recording medium P with polarity opposite to that of toner. Thus, a toner image on the electrophotographic photosensitive member 21 is electrostatically transferred to the front surface of the recording medium P at the contact portion between the electrophotographic photosensitive member 21 and the transfer roller 25.

The recording medium P to which the toner image has been transferred is separated from the electrophotographic photosensitive member 21 and is conveyed into a toner image fixing device (not shown). After the toner image is fixed, the recording medium P is output as an image-formed material. When residual charge remains on the electrophotographic photosensitive member 21, the residual charge on the electrophotographic photosensitive member 21 may be removed with a pre-exposure apparatus (not shown) after transfer and before primary charging with the charging roller 22.

The process cartridge integrally supports at least the charging roller 22 and the electrophotographic photosensitive member 21 and can be attached to and detached from the main body of the electrophotographic apparatus.

### EXEMPLARY EMBODIMENTS

The present invention will be further described below with specific exemplary embodiments. However, the present invention is not limited to these exemplary embodiments. The term “part” in the exemplary embodiments refers to “part by mass”.

First, a method for synthesizing acrylic polymers used in the exemplary embodiments and comparative examples is described below.

### Acrylic Polymer (N+−1)

A commercial product (trade name: 1SX-10555, manufactured by Taisei Fine Chemical Co., Ltd.) was prepared as an acrylic polymer (N+−1).

The acrylic polymer (N+−1) has the structure represented by the formula (1) and the structure represented by the formula (2) on its side chains. More specifically, in the formula (1), X⁻ is Cl⁻, and R₁ to R₃ are independently a methyl group, and in the formula (2), α is 134, and R₅ to R₇ are independently a methyl group.

The acrylic polymer (N+−1) had a weight-average molecular weight of 16,000 as measured by GPC under the following conditions. A calibration curve was prepared using standard polystyrene (trade name: EasiCal PS-1, manufactured by Polymer Laboratories).
Temperature: 40° C.
Solvent: THF
Flow rate: 0.5 mL/min
GPC apparatus: HLC-8220 GPC system (manufactured by Tosoh Corporation)
Column: One Shodex GPC LF-G+two Shodex GPC LF-404 (trade name, manufactured by Showa Denko K.K.)
Detector: Ultraviolet absorption detector (trade name: UV-8220, manufactured by Tosoh Corporation)

### Acrylic Polymer (N+−2)

An acrylic polymer (N+−2) was synthesized by the following method.

First, 213.5 g of hexane (manufactured by Kanto Chemical Co., Inc., >96%) and 10.0 g of benzoyl peroxide (manufactured by Tokyo Chemical Industry Co., Ltd., 25% by weight) were stirred in a flask under a nitrogen stream. Then, 100.2 g of methyl methacrylate (manufactured by Tokyo Chemical Industry Co., Ltd., 99.8%), 10.0 g of a methacrylic modified silicone oil (trade name: X-22-174ASX, manufactured by Shin-Etsu Chemical Co., Ltd.), and 37.5 g of methacryloylcholine chloride (manufactured by Tokyo Chemical Industry Co., Ltd., 80% by weight) were slowly added dropwise to the flask. The mixture was stirred at 60° C. for another 2 hours and was left to cool to room temperature, thus yielding the acrylic polymer (N+−2).

The acrylic polymer (N+−2) had a weight-average molecular weight of 22,000 as measured by GPC under the same conditions as for the acrylic polymer (N+−1).

The methacrylic modified silicone oil “X-22-174ASX” corresponds to the acrylic monomer represented by the formula (15) in which R₄₆, R₄₈, and R₄₉ are independently a methyl group, R₄₇ is —OCO—C₃H₆—, R₅₀ is a methyl group or a n-butyl group, and α is 10. Thus, the acrylic polymer (N+−2) has the structure represented by the formula (2) in which R₅ and R₆ are independently a methyl group, R₇ is a methyl group or a n-butyl group, and α is 10.

### Acrylic Polymer (N+−3)

An acrylic polymer (N+−3) was synthesized in the same manner as in the acrylic polymer (N+−2) except that the amount of benzoyl peroxide was changed to 0.084 g. The acrylic polymer (N+−3) had a weight-average molecular weight of 5,500 as measured by GPC in the same manner as for the acrylic Polymer (N+−1).

### Acrylic Polymer (N+−4)

An acrylic polymer (N+−4) was synthesized by the following method.

First, 207.1 g of hexane (manufactured by Merck & Co., Inc., >99%) and 0.0034 g of benzoyl peroxide (manufactured by Tokyo Chemical Industry Co., Ltd., 25% by weight) were stirred in a flask under a nitrogen stream. Then, 100.2 g of methyl methacrylate (manufactured by Tokyo Chemical Industry Co., Ltd., 99.8%), 10.0 g of a methacryl-modified silicone oil (trade name: X-22-174ASX, manufactured by Shin-Etsu Chemical Co., Ltd.), and 37.5 g of methacryloylcholine chloride (manufactured by Tokyo Chemical Industry Co., Ltd., 80% by weight) were slowly added dropwise to the flask. The mixture was stirred at 80° C. for another 2 hours and was left to cool to room temperature, thus yielding the acrylic polymer (N+−4). The acrylic polymer (N+−4) had a weight-average molecular weight of 92,000 as measured by GPC in the same manner as for the acrylic Polymer (N+−1).

### Acrylic Polymer (N+−5)

An acrylic polymer (N+−5) was synthesized by the following method.

First, 213.5 g of hexane (manufactured by Kanto Chemical Co., Inc., >96%) and 0.017 g of benzoyl peroxide (manufactured by Tokyo Chemical Industry Co., Ltd., 25% by weight) were stirred in a flask under a nitrogen stream. Then, 100.2 g of methyl methacrylate (manufactured by Tokyo Chemical Industry Co., Ltd., 99.8%) and 37.5 g of methacryloylcholine chloride (manufactured by Tokyo Chemical Industry Co., Ltd., 80% by weight) were slowly added dropwise to the flask. The mixture was stirred at 60° C. for another 2 hours and was left to cool to room temperature, thus yielding the acrylic polymer (N+−5). The acrylic polymer (N+−5) had no group having an organosiloxane bond.

### Exemplary Embodiment 1

### [1] Formation and Evaluation of Conductive Elastic Layer

The materials listed in Table 1 were mixed in a 6-L pressure kneader TD6-15MDX (trade name, manufactured by Toshin Co., Ltd.) at a filling ratio of 70% by volume and at a blade rotational speed of 30 rpm for 24 minutes to produce an unvulcanized rubber composition. Then, 4.5 parts of a vulcanization accelerator tetrabenzylthiuram disulfide (trade name: Sanceler TBZTD, manufactured by Sanshin Chemical Industry Co., Ltd.) and 1.2 parts of a vulcanizing agent sulfur were added to 174 parts of the unvulcanized rubber composition. The unvulcanized rubber composition was turned over 20 times on an open-roll mill having a roll diameter of 30.5 cm (12 inch). The front roll rotational speed was 8 rpm, and the rear roll rotational speed was 10 rpm. The roll gap was 2 mm. After the roll gap was narrowed to 0.5 mm, the unvulcanized rubber composition was subjected to tight milling 10 times to produce a mixture I for the elastic layer.

TABLE 1

| | |
|---|---|
| Raw materials | Use amount |

| | | |
|---|---|---|
| Medium high nitrile rubber NBR | 100 | parts |
| [Trade name: Nipol DN219, center value of amount | | |
| of bonded acrylonitrile 33.5%, center value of | | |
| Mooney viscosity 27, manufactured by Zeon] | | |
| Carbon black for color (filler) | 48 | parts |
| [Trade name: #7360SB, particle size 28 nm, | | |
| nitrogen adsorption specific surface area 77 | | |
| m2/g, amount of absorbed DBF 87100 cm3/100 g, | | |
| manufactured by Tokai Carbon] | | |
| Calcium carbonate (filler) | 20 | parts |
| [Trade name: Nanox #30, manufactured by Maruo | | |
| Calcium] | | |
| Zinc oxide | 5 | parts |
| Zinc stearate | 1 | part |

A cylindrical (nickel-plated) steel support having a diameter of 6 mm and a length of 252 mm was prepared. A thermosetting adhesive containing metal and rubber (trade name: Metaloc U-20, manufactured by Toyo Kagaku Kenkyusho Co., Ltd.) was applied to a central cylindrical region of the support. The central cylindrical region had a width of 231 mm (115.5 mm from the center toward each end of the support in the axial direction). The thermosetting adhesive was dried at a temperature of 80° C. for 30 minutes and then at a temperature of 120° C. for 1 hour. Thus, a support having the adhesive layer was produced.

The support having the adhesive layer and the mixture I was coaxially extruded. The cylindrical extrudate had an outer diameter in the range of 8.75 to 8.90 mm. The end portions of the cylindrical extrudate were cut off. Thus, a conductive elastic roller No. 1 having the unvulcanized conductive elastic layer around the support was produced.

The conductive elastic roller No. 1 was then heated for vulcanization at 80° C. for 30 minutes and then at 160° C. for 30 minutes. Thus, a conductive elastic roller No. 2 was produced.

Both ends of the conductive elastic layer portion (rubber portion) of the conductive elastic roller No. 2 were cut off before surface polishing. The conductive elastic layer portion had a width of 232 mm in the axial direction. The surface of the conductive elastic layer portion was then polished with a grindstone. A conductive elastic roller No. 3 (a conductive elastic roller after surface polishing) thus produced had an end diameter of 8.26 mm and a central diameter of 8.50 mm and had a crown shape.

### [2] Synthesis of Condensate and Evaluation of Charge

### Polarity

### Synthesis of Condensate No. 1

A condensate No. 1 for forming a surface layer was synthesized as described below.

The components listed in Table 2 were mixed in a 300-ml flask and were heated under reflux at 100° C. for 20 hours to produce a condensate intermediate No. 1 of a hydrolyzable silane compound.

TABLE 2

| Raw materials | Use amount |
|---|---|
| 3-glycidoxypropyltrimethoxysilane (EP-1) | 25.1 g |
| (manufactured by Shin-Etsu Chemical) | |
| Hexyltrimethoxysilane (He) (manufactured by | 21.9 g |
| Shin-Etsu Chemical) | |
| Ion-exchanged water | 11.4 g |
| Ethanol (manufactured by Kishida Chemical) | 106.4 g |

The condensate intermediate No. 1 was cooled to room temperature and was mixed with 12.1 g (0.042 mol) of tetraisopropoxytitanium (manufactured by Kojundo Chemical Laboratory Co., Ltd.) at room temperature for 3 hours to produce a condensate No. 1.

The condensate No. 1 was then mixed with 4.3 g of the acrylic polymer (N+−1) having a quaternary ammonium group and a group having an organosiloxane bond (trade name: 1SX-10555, Taisei Fine Chemical Co., Ltd.) to produce a liquid mixture No. 1.

Then, 82.5 g of a mixed solvent of ethanol:2-butanol=1:1 (mass ratio) and 2.9 g of a cationic polymerization initiator (SP-150, manufactured by Adeka Corporation) diluted to 10% with acetone were added to 14.6 g of the liquid mixture No. 1. Thus, a coating solution No. 1 was produced.

### Evaluation (1): Measurement of Charge Polarity of Coating Film

The coating solution No. 1 was applied to a SUS sheet with a spin coater and was dried. The coating film was then irradiated with ultraviolet light having a wavelength of 254 nm. The integral light quantity was 9000 mJ/cm². The resulting sample sheet had the coating film having a thickness of approximately 300 nm.

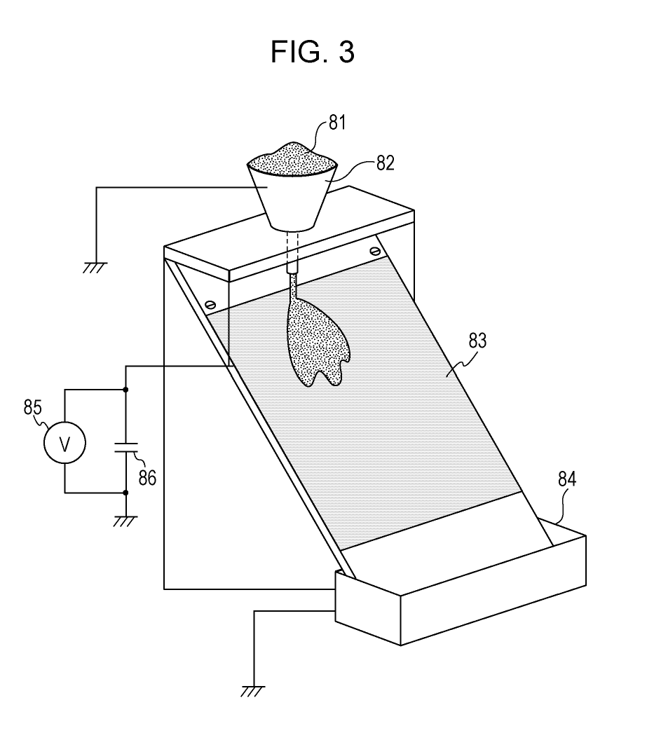

The sample sheet was placed on a surface charge measuring apparatus TS-100AS (manufactured by Toshiba Chemical Corporation) illustrated in FIG. 3 (a sample sheet 83). An electrometer 85 was grounded (0 V). The sample sheet 83 was grounded at 23° C. and at 60% RH at least overnight. The Imaging Society of Japan standard carrier N-01 was used as carrier particles 81. The carrier particles 81 were grounded at 23° C. and at 60% RH at least overnight.

A START switch was pressed to allow the carrier particles 81 in a dropping funnel 82 to fall on the sample sheet 83 for 20 seconds. The carrier particles 81 were received in a grounded container 84. The charge amount Q (μC) was read on the electrometer 85. The measurement was performed at 23° C. and at 60% RH. Reference numeral 86 in FIG. 3 denotes a capacitor.

The amount of electrical charge of carrier particles per unit mass Q/M (μC/g) was calculated from the charge amount Q (μC) and the mass M (g) of the collected carrier particles.

Higher Q/M values on the charging member surface indicate that the charging member can more easily negatively charge negatively chargeable toner on friction with the toner. Thus, higher Q/M measured by the method indicates that the charging member having the surface layer formed from the coating solution is more effective in decreasing the amount of weakly negatively charged toner or positively charged toner electrostatically adhering to the charging member. Table 6 shows the results.

### [3] Manufacture and Evaluation of Charging Roller

The coating solution No. 1 was applied by ring coating to the conductive elastic layer of the conductive elastic roller No. 3 (the conductive elastic roller after surface polishing) (total ejection amount: 0.100 ml, speed at a ring portion: 85 mm/s). The surface of the conductive elastic roller No. 3 was irradiated with ultraviolet light having a wavelength of 254 nm to cure the coating film of the coating solution No. 1. The integral light quantity was 9000 mJ/cm². Thus, the surface layer was formed. A low-pressure mercury lamp (manufactured by Harison Toshiba Lighting Corporation) was used for ultraviolet radiation. A charging roller No. 1 was produced in this manner.

### Evaluation (2): Evaluation of Amount of Soiling on Charging Roller

Image evaluation was performed with the charging roller No. 1 as described below.

A laser beam printer (Satera LBP3100, manufactured by CANON KABUSHIKI KAISHA) was prepared for image evaluation. A cleaning member was removed from an electrophotographic photosensitive member in a process cartridge of the laser beam printer. This is because removal of the cleaning process allows an accelerated test for a charging roller under the conditions where toner and toner external additives are likely to adhere to the surface of the charging roller. Furthermore, the laser beam printer was modified such that the charging roller can rotate at a peripheral speed of 120% of the peripheral speed of the electrophotographic photosensitive member. This is because the charging roller can be evaluated under conditions where the charging roller can sufficiently charge toner due to enhanced friction between the charging roller and the toner. The charging roller No. 1 was installed in the process cartridge, and the process cartridge was placed in the electrophotographic apparatus.

An electrophotographic image was printed on 3,000 sheets at a print density of 1% at 10° C. and at 15% RH. The charging roller was then removed from the process cartridge. The amount of toner adhering to the charging roller was measured.

The amount of toner adhering to the charging roller was measured as described below. Toner adhering to the charging roller was removed by a cellophane adhesive tape. The cellophane adhesive tape was put on a blank sheet of paper. A clean cellophane adhesive tape was also put on a blank sheet of paper. The reflection densities of the cellophane adhesive tape to which the toner adhered and the clean cellophane adhesive tape were measured with a photovoltaic reflection densitometer (trade name: TC-6DS/A, manufactured by Tokyo Denshoku. Co., Ltd.). The reflection densities were converted into the amount of adhering toner using the following formula (22).

Amount of adhering toner (%)={(Reflection density of clean portion)−(Reflection density of toner adhering portion)}/(Reflection density of clean portion) (22)

On the basis of the amount of adhering toner, the amount of soiling of the charging roller was rated as described below. Table 6 shows the results.
Rank “A”: Less than 10%.
Rank “B”: 10% or more and less than 30%.
Rank “C”: 30% or more and less than 60%.
Rank “D”: 60% or more.

### Exemplary Embodiments 2 to 13

Coating solutions No. 2 to No. 13 were produced in the same manner as in Exemplary Embodiment 1 except that the compositions of the coating solutions were changed as listed in Table 3. The coating solutions were subjected to the evaluation (1).

In Exemplary Embodiments 4 and 7 to 10, in which the hydrolyzable titanium compound was not added, stirring at room temperature for 3 hours performed in Exemplary Embodiment 1 was omitted. In Exemplary Embodiments 7 to 11, in which the hydrolyzable silane compound had no epoxy group, no cationic polymerization initiator was added to prepare the coating solutions. When a modified silicone oil was used as a polysiloxane, the step of producing a condensate was omitted. The abbreviations in Table 3 were described in Table 4.

Charging rollers No. 2 to No. 13 were produced in the same manner as in Exemplary Embodiment 1 and were subjected to the evaluation (2). Table 6 shows the results.

TABLE 3

| | Liquid mixture/g | | | | | | | | | | | | | |
|---|---|---|---|---|---|---|---|---|---|---|---|---|---|---|
| | Polysiloxane | | | | | | | | | Acrylic polymer | | | | |
| | EP-1 | EP-2 | EP-3 | He | TEOS | Si oil | Ti | Water | EtOH | N +− 1 | N +− 2 | N +− 3 | N +− 4 | N +− 5 |
| Exemplary embodiment 1 | 25.1 | — | — | 21.9 | — | — | 12.1 | 11.4 | 106.4 | 4.3 | — | — | — | — |
| Exemplary embodiment 2 | 18.2 | — | — | 15.9 | — | — | 43.7 | 8.2 | 90.8 | 4.3 | — | — | — | — |
| Exemplary embodiment 3 | 26.3 | — | — | 23.0 | — | — | 6.3 | 11.9 | 109.2 | 4.3 | — | — | — | — |
| Exemplary embodiment 4 | 50.5 | — | — | — | — | — | — | 11.4 | 114.9 | 4.3 | — | — | — | — |
| Exemplary embodiment 5 | — | 29.9 | — | 19.6 | — | — | 10.8 | 10.1 | 106.4 | 4.3 | — | — | — | — |
| Exemplary embodiment 6 | — | — | 25.1 | 21.3 | — | — | 11.7 | 11.0 | 107.7 | 4.3 | — | — | — | — |
| Exemplary embodiment 7 | — | — | — | 53.7 | — | — | — | 13.9 | 109.2 | 4.3 | — | — | — | — |
| Exemplary embodiment 8 | — | — | — | — | 122.6 | — | — | 31.8 | 22.4 | 0.9 | — | — | — | — |
| Exemplary embodiment 9 | — | — | — | — | 122.6 | — | — | 31.8 | 22.4 | 4.3 | — | — | — | — |
| Exemplary embodiment 10 | — | — | — | — | 122.6 | — | — | 31.8 | 22.4 | 8.6 | — | — | — | — |
| Exemplary embodiment 11 | — | — | — | — | — | 4.9 | 85.8 | 2.2 | 82.3 | 3.5 | — | — | — | — |
| Exemplary embodiment 12 | 25.1 | — | — | 21.9 | — | — | 12.1 | 11.4 | 106.4 | — | 4.6 | — | — | — |
| Exemplary embodiment 13 | 37.1 | — | — | — | 32.4 | — | — | 33.6 | 73.6 | — | 4.6 | — | — | — |
| Exemplary embodiment 15 | 25.1 | — | — | 21.9 | — | — | 12.1 | 11.4 | 106.4 | — | — | 4.6 | — | — |
| Exemplary embodiment 16 | 25.1 | — | — | 21.9 | — | — | 12.1 | 11.4 | 106.4 | — | — | — | 4.6 | — |
| Comparative example 1 | — | — | — | — | 122.6 | — | — | 31.8 | 22.4 | — | — | — | — | — |
| Comparative example 2 | 25.1 | — | — | 21.9 | — | — | — | 11.4 | 106.4 | — | — | — | — | 5.1 |

| | Coating solution/g | | |
|---|---|---|---|
| | Liquid mixture | Solvent | Polymerization initiator |
| Exemplary embodiment 1 | 14.6 | 82.5 | 2.9 |
| Exemplary embodiment 2 | 14.6 | 83.3 | 2.1 |
| Exemplary embodiment 3 | 14.6 | 82.4 | 3.0 |
| Exemplary embodiment 4 | 14.6 | 79.6 | 5.8 |
| Exemplary embodiment 5 | 14.6 | 82.8 | 2.5 |
| Exemplary embodiment 6 | 14.6 | 82.6 | 2.7 |
| Exemplary embodiment 7 | 14.6 | 85.4 | — |
| Exemplary embodiment 8 | 14.9 | 85.1 | — |
| Exemplary embodiment 9 | 14.6 | 85.4 | — |
| Exemplary embodiment 10 | 14.3 | 85.7 | — |
| Exemplary embodiment 11 | 17.7 | 82.3 | — |
| Exemplary embodiment 12 | 14.7 | 82.5 | 2.9 |
| Exemplary embodiment 13 | 14.7 | 81.1 | 4.2 |
| Exemplary embodiment 15 | 14.7 | 82.5 | 2.9 |
| Exemplary embodiment 16 | 14.3 | 82.8 | 2.9 |
| Comparative example 1 | 15.0 | 85.0 | — |
| Comparative example 2 | 14.3 | 52.9 | 2.9 |

TABLE 4

| Abbreviations | | | | | Concen- |
|---|---|---|---|---|---|
| in Table 3 | Name | Structure | Manufacturer | MW | tration |
| EP-1 | 3-glycidoxypropyltrimethoxysilane | 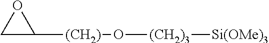 | Shin-Etsu Chemical | 236 | 100% |
| EP-2 | 8-oxiran-2-yloctyltriethoxysilane | 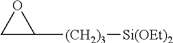 | SiKÉMIA | 319 | 100% |
| EP-3 | 1-(3,4- epoxycyclohexyl)ethyltrimethoxysilane | 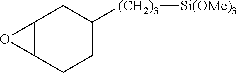 | Shin-Etsu Chemical | 246 | 100% |
| He | Hexyltrimethoxysilane | H₃C—(CH₂)₅—Si(OMe)₃ | Shin-Etsu Chemical | 206 | 100% |
| TEOS | Tetraethoxysilane | Si(OEt)4 | Shin-Etsu Chemical | 240 | 100% |
| Si oil | FZ-3527 | 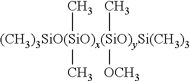 | Dow Corning Toray | (Equivalent 95) | 99% |
| Ti | Tetraisopropoxytitanium | Ti—(O i-Pr)₄ | Kojundo Chemical | 284 | 95% |
| | | | Laboratory | | |
| N + −1 | 1SX-1055S | Acrylic polymer 1 | Taisei Fine Chemical | 16000 | 41% |
| N + −2 | — | Acrylic polymer 2 | — | 22000 | 39% |
| N + −3 | — | Acrylic polymer 3 | — | 5500 | 39% |
| N + −4 | — | Acrylic polymer 4 | — | 90000 | 39% |
| N + −5 | — | Acrylic polymer 5 | — | — | 39% |
| [SQ-100] | SQ-100 | Silicone-modified acrylic resin | Tokushiki | — | 41% |
| [UAX-615] | UAX-615 | Isocyanurate type polyisocyanate | Tokushiki | — | — |
| | | (curing agent) | | | |
| [UA-38] | UA-38 | Tin catalyst | Tokushiki | — | — |

*Me: Methyl group, Et: Ethyl group, i-Pr: Isopropyl group, Bu: Butyl group

### Exemplary Embodiment 14

The materials listed in Table 5 were stirred at room temperature for 15 minutes to produce a coating solution No. 14. The coating solution No. 14 was subjected to the evaluation (1). The coating solution No. 14 was not exposed to ultraviolet radiation, but was dried on the SUS sheet and was cured at 100° C. for 40 minutes. The coating solution No. 14 was then applied to the conductive elastic layer in the same manner as in Exemplary Embodiment 1, was dried, and was cured at 100° C. for 40 minutes. A charging roller No. 14 thus produced was subjected to the evaluation (2). Table 6 shows the results.

TABLE 5

| Raw materials | Use amount (g) |
|---|---|
| SQ-100 | 5.4 |
| UAX-615 | 1.1 |
| UA-38 | 1.8 |
| Methyl ethyl ketone | 190.0 |
| N+ − 1 | 7.1 |

### Exemplary Embodiments 15 and 16

Coating solutions No. 15 and No. 16 were produced in the same manner as in Exemplary Embodiment 1 except that the compositions of the coating solutions were changed as listed in Table 3. The coating solutions were subjected to the evaluation (1). Charging rollers No. 15 and No. 16 were produced in the same manner as in Exemplary Embodiment 1 and were subjected to the evaluation (2). Table 6 shows the results.

### Comparative Examples 1 and 2

Coating solutions No. 17 and No. 18 were produced in the same manner as in Exemplary Embodiment 1 except that the compositions of the coating solutions were changed as listed in Table 3. The coating solutions were subjected to the evaluation (1). Charging rollers No. 17 and No. 18 were produced in the same manner as in Exemplary Embodiment 1 and were subjected to the evaluation (2). Table 6 shows the results.

TABLE 6

| | Evaluation (1) | |
|---|---|---|
| | Q/M (×10⁻³) | Evaluation (2) |
| Exemplary embodiment 1 | 5.5 | A |
| Exemplary embodiment 2 | 4.5 | B |
| Exemplary embodiment 3 | 6.0 | A |
| Exemplary embodiment 4 | 5.2 | A |
| Exemplary embodiment 5 | 4.8 | B |
| Exemplary embodiment 6 | 4.0 | B |
| Exemplary embodiment 7 | 6.1 | A |
| Exemplary embodiment 8 | 7.8 | A |
| Exemplary embodiment 9 | 2.1 | C |
| Exemplary embodiment 10 | 4.4 | B |
| Exemplary embodiment 11 | 7.2 | A |
| Exemplary embodiment 12 | 3.9 | B |
| Exemplary embodiment 13 | 4.2 | B |
| Exemplary embodiment 14 | 4.9 | B |
| Exemplary embodiment 15 | 4.3 | B |
| Exemplary embodiment 16 | 4.8 | B |
| Comparative example 1 | −1.1 | D |
| Comparative example 2 | 1.4 | D |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-162928, filed on Aug. 8, 2014, which is hereby incorporated by reference herein in its entirety.

1. A charging member, comprising:
a support; and
a surface layer,
wherein the surface layer comprises a first compound and a second compound different from the first compound,
the first compound is a polysiloxane having at least one unit selected from the group consisting of SiO_{4/2}(Q) unit, SiO_{3/2}(T) unit, and SiO_{2/2}(D) unit, and
the second compound is an acrylic polymer having
a quaternary ammonium group and
a group having an organosiloxane bond.

2. The charging member according to claim 1, wherein the second compound has a structure represented by the following formula (1) and a structure represented by the following formula (2): 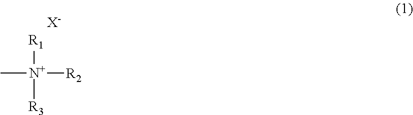
wherein R₁ to R₃ independently denote a hydrogen atom, an alkyl group having 1 to 10 carbon atoms, a phenyl group, an alkoxy group having 1 to 10 carbon atoms, or a phenoxy group, and X⁻ denotes an anion, 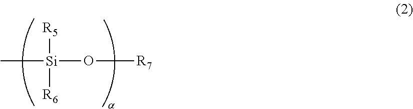
wherein R₅ and R₆ independently denote a hydrogen atom or an alkyl group having 1 to 3 carbon atoms, R₇ denotes a hydrogen atom, an alkyl group having 1 to 6 carbon atoms, or a group represented by the following formula (3), and α is an integer of 1 or more.
—Si(CH₃)₃ (3)

3. The charging member according to claim 2, wherein the second compound includes constitutional units represented by the following formulae (17) and (18): 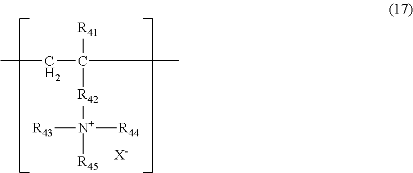
wherein R₄₁ denotes a hydrogen atom or an alkyl group having 1 to 3 carbon atoms, R₄₃ to R₄₅ independently denote a hydrogen atom, an alkyl group having 1 to 10 carbon atoms, a phenyl group, an alkoxy group having 1 to 10 carbon atoms, or a phenoxy group, R₄₂ denotes a divalent group having a structure represented by —COO—, and X⁻ denotes an anion, 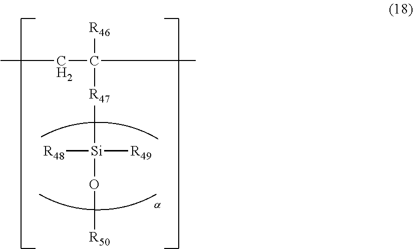
wherein R₄₆ denotes a hydrogen atom or an alkyl group having 1 to 3 carbon atoms, R₄₈ and R₄₉ independently denote a hydrogen atom or an alkyl group having 1 to 3 carbon atoms, R₅₀ denotes a hydrogen atom, an alkyl group having 1 to 6 carbon atoms, or a group represented by the formula (3), R₄₇ denotes a divalent group having a structure represented by —COO— or —O—, and α is an integer of 1 or more.

4. The charging member according to claim 2, wherein the anion is Br⁻, Cl⁻, HSO₄⁻, H₂PO₄⁻, NO₃⁻, a methylsulfonate ion, or a p-toluenesulfonate ion.

5. The charging member according to claim 2, wherein α is an integer of 1 or more and 200 or less.

6. The charging member according to claim 1, wherein the first compound has at least one of the SiO_{4/2}(Q) unit and the SiO_{3/2}(T) unit.

7. The charging member according to claim 6, wherein the first compound includes a constitutional unit represented by the following formula (4): 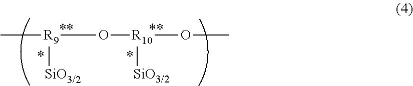
wherein R₉ and R₁₀ independently denote a structure represented by one of the following formulae (5) to (8): 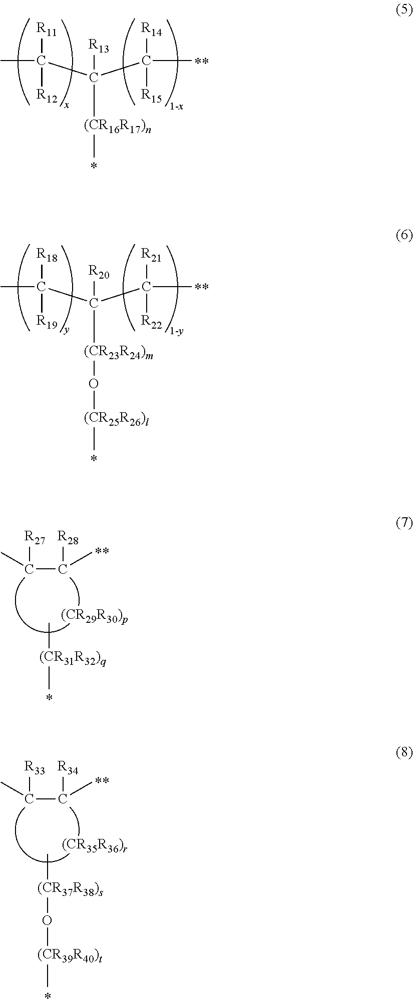
wherein R₁₁ to R₁₅, R₁₈ to R₂₂, R₂₇, R₂₈, R₃₃, and R₃₄ independently denote a hydrogen atom, an alkyl group having 1 to 4 carbon atoms, a hydroxy group, a carboxy group, or an amino group, R₁₆, R₁₇, R₂₃ ^{to} R₂₆, R₃₁, R₃₂, and R₃₇ to R₄₀ independently denote a hydrogen atom or an alkyl group having 1 to 4 carbon atoms, R₂₉, R₃₀, R₃₅, and R₃₆ independently denote a hydrogen atom, an alkoxy group having 1 to 4 carbon atoms, or an alkyl group having 1 to 4 carbon atoms, n, m, l, q, s, and t are independently an integer of 1 or more and 8 or less, p and r are independently an integer of 4 or more and 12 or less, x and y are independently 0 or 1, a symbol “*” represents a binding site with a silicon atom in the formula (4), and a symbol “**” represents a binding site with an oxygen atom disposed on the right of R₉ in the formula (4) in the case that R₉ in the formula (4) denotes a structure having one of the formulae (5) to (8) and represents a binding site with an oxygen atom disposed on the right of R₁₀ in the formula (4) in the case that R₁₀ in the formula (4) denotes a structure having one of the formulae (5) to (8).

8. The charging member according to claim 6, wherein the first compound is a ladder-silicone-modified acrylic polymer.

9. The charging member according to claim 6, wherein the first compound has a structure derived from a modified silicone oil.

10. The charging member according to claim 1, wherein the first compound further includes a constitutional unit represented by the following formula (9).
TiO_{4/2} (9)

11. A process cartridge configured to integrally support an electrophotographic photosensitive member and a charging member, the charging member being configured to charge a surface of the electrophotographic photosensitive member, the process cartridge being attachable to and detachable from a main body of an electrophotographic apparatus,
wherein the charging member comprises
a support; and
a surface layer,
the surface layer comprising a first compound and a second compound different from the first compound,
the first compound is a polysiloxane having at least one unit selected from the group consisting of SiO_{4/2}(Q) unit, SiO_{3/2}(T) unit, and SiO_{2/2}(D) unit, and
the second compound is an acrylic polymer having
a quaternary ammonium group and
a group having an organosiloxane bond.

12. An electrophotographic apparatus comprising:
an electrophotographic photosensitive member; and
a charging member configured to charge a surface of the electrophotographic photosensitive member,
wherein the charging member comprises
a support; and
a surface layer,
the surface layer comprising a first compound and a second compound different from the first compound,
the first compound is a polysiloxane having at least one unit selected from the group consisting of SiO_{4/2}(Q) unit, SiO_{3/2}(T) unit, and SiO_{2/2}(D) unit, and
the second compound is an acrylic polymer having
a quaternary ammonium group and
a group having an organosiloxane bond.
